(19) United States
(12) Patent Application Publication
(10) Pub. No.: US 2009/0313361 A1
(43) Pub. Date: Dec. 17, 2009

(54) MANAGEMENT METHOD OF LOCAL AREA NETWORK AND DEVICE THEREOF

(75) Inventors: Fong-Chi Chan, Taipei (TW); Yen-Ming Cho, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/431,739

(22) Filed: Apr. 28, 2009

(30) Foreign Application Priority Data
Jun. 11, 2008 (TW) 97121771

(51) Int. Cl. G06F 15/177

(52) U.S. Cl. 709/222

(57) ABSTRACT

A management method of local area network (LAN) and a device thereof adapted to a network terminal are provided. The management method of LAN detects whether a network interface provides a dynamic host configuration protocol (DHCP). A static address is provided for the network terminal when the network interface does not provide the DHCP. Thereby, an interaction between the network terminal and other terminals in the LAN can be performed via the static address. In addition, the static address of the network terminal is canceled when the network interface provides the DHCP, so that the network terminal can operate in the LAN by following the DHCP.

### CROSS-REFERENCE TO RELATED APPLICATION

This application claims the priority benefit of Taiwan application serial no. 97121771, filed on Jun. 11, 2008. The entirety of the above-mentioned patent application is hereby incorporated by reference herein and made a part of specification.

### BACKGROUND OF THE INVENTION

1. Field of the Invention

The present invention relates to a management method of local area network (LAN) and a device thereof, and particularly relates to a management method and a device thereof for timely providing a static address to a network terminal in the LAN.

2. Description of Related Art

As digital technology and communication network develop, the trend of digital life is flourishing. The so-called digital life has the characteristics of intelligent operation interface and favorable communication capacity. In view of operation interface, digital life has adopted human expressions such as voices, actions, or emotions to operate digital appliances, instead of traditional interfaces such as switches, keyboards, or mice. As for communication, digital appliances are interconnected or connected to the Internet for receiving instructions from the outside and updating the statuses thereof, so as to achieve the purposes of home security and remote control.

For instance, a user may monitor his/her house via video cameras connected to the Internet or control the switches of appliances when being away from home. Further, because the digital appliances are connected with one another, the user is not required to monitor the digital appliances by himself. For example, when a video camera detects intrusion from the outside, recording devices may be timely activated to record the intrusion; and when an air conditioner is turned on, the doors and windows may be closed automatically. All these new functions and advantages of digital life are realized by the communication network.

As described above, in order to precisely connect the appliances to be controlled, generally a dynamic host configuration protocol (DHCP) is used for providing Internet protocol addresses (IP addresses) to each appliance, so that the user may control via Internet. Basically, the DHCP allows an appliance to broadcast via its own Ethernet and acquire network settings such as IP address, netmask, and default gateway from the service device providing the DHCP. Through the service device, the user does not need to set up the network in each appliance.

However, the aforesaid service device, such as an IP sharer or a network access point (AP), may exist or be removed at any time. Moreover, even if the service device exists, its function of providing the DHCP may be disabled. If the DHCP is not provided in the LAN, the user has to go through complex procedure of manually setting up the address of each appliance, so as to construct the LAN for the appliances to interconnect and interact with one another. Such a procedure is not user-friendly. Therefore, a function of automatically distributing addresses is required for the user to timely control the appliances.

In addition, if the DHCP is provided in the LAN, the appliances in the LAN need to accept the IP addresses provided by the service device, so as to connect to the Internet. For this reason, how to automatically distribute addresses without conflicting with the DHCP is also very important.

### SUMMARY OF THE INVENTION

The present invention provides a management method of local area network (LAN) and a device thereof for timely and automatically distributing a static address not conflicting with a system to a network terminal, so as to omit a complex procedure of manually setting up an address of the network terminal and allow the network terminal to connect and interact with other terminals in the LAN via the static address.

The present invention provides a management method of LAN applicable to a network terminal. The management method is to detect whether or not a network interface provides a dynamic host configuration protocol (DHCP). The static address is provided to the network terminal when the network interface does not provide the DHCP, and the static address of the network terminal is canceled when the network interface provides the DHCP.

From another aspect, the present invention further provides a management device of LAN applicable to a network terminal. The management device comprises a detection unit and a control unit. The detection unit detects whether or not the network interface provides the DHCP. When the network interface does not provide the DHCP, the control unit provides the static address to the network terminal according to a predetermined format. When the network interface provides the DHCP, the control unit cancels the static address of the network terminal.

The present invention has the advantages that the conventional complex procedure of manually setting up the address of the network terminal is not required. In addition, the network terminal can operate to connect to the Internet by following the DHCP without encountering conflicts due to different address setting.

In order to make the above and other objectives, features and advantages of the present invention more comprehensible, preferable embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram illustrating a management device of local area network according to an embodiment of the present invention.

FIG. 1B is a diagram illustrating a local area network according to an embodiment of the present invention.

FIG. 1C is a diagram illustrating a local area network according to another embodiment of the present invention.

FIG. 2 is a process flow illustrating a management method of local area network according to an embodiment of the present invention.

### DESCRIPTION OF EMBODIMENTS

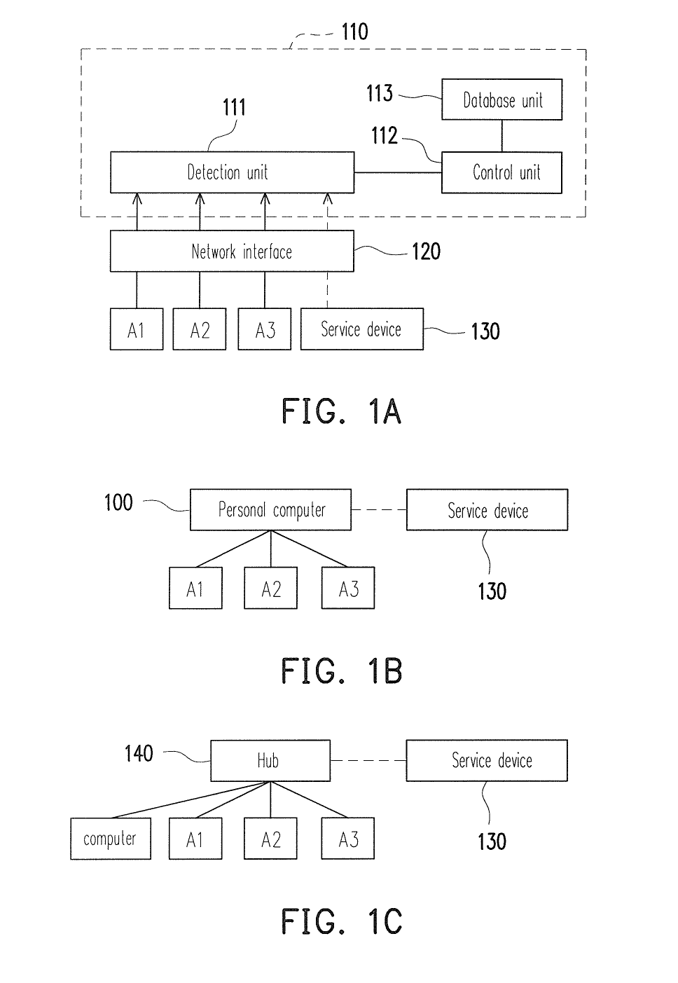

FIG. 1A is a diagram illustrating a management device of LAN according to an embodiment of the present invention. Referring to FIG. 1A, a management device 110 comprises a detection unit 111, a control unit 112, and a database unit 113. In this embodiment, a dynamic host configuration protocol (hereafter called DHCP) is provided by a service device 130. The service device 130 is, for example, a router, a wireless network access point, or a DHCP server. A network interface 120 is, for example, a physical layer element such as a wired network card, a wireless network card, or an infrared transceiver.

In this embodiment, solid-line arrows indicate that network terminals A1˜A3 are connected to the management device 110 via the network interface 120. In FIG. 1A, dotted-line arrow indicates that the service device 130 is connected to the management device 110 via the network interface 120, but the service device 130 may exist or be removed at any time. In other embodiments, the dotted-line arrow may also indicate that a DHCP function of the service device 130 is disabled.

Referring to FIG. 1A, the detection unit 111 may be used to detect whether or not the network interface 120 provides the DHCP. The control unit 112 is coupled to the detection unit 111. If the detection unit 111 detects that the network interface 120 does not provide the DHCP, the service device 130 may be removed or the DHCP function may be disabled. In the meantime, the control unit 112 may provide static addresses to the network terminals A1˜A3 according to a predetermined format, wherein the static addresses of the network terminals A1˜A3 are different from one another and do not conflict in an existing network device (detailed description thereof is provided hereafter).

When the detection unit 111 detects that the network interface 120 provides the DHCP, the control unit 112 cancels the static addresses of the network terminals A1˜A3 and controls the network terminals A1˜A3 to request the service device 130 to provide Internet protocol addresses (IP addresses) for connecting to the Internet. The database unit 113 is coupled to the control unit 112 for storing the static addresses.

FIG. 1B is a diagram illustrating a local area network according to an embodiment of the present invention. Referring to FIGS. 1A and 1B, the management device 110 in FIG. 1A is, for example, disposed in a personal computer 100 as shown in FIG. 1B, but the present invention is not limited thereto. In other embodiments, the personal computer 100 may be replaced by other electronic devices providing Internet access.

In this embodiment, a communication network including the personal computer 100 and the network terminals A1˜A3 needs to be constructed, so as to manage and control the network terminals A1˜A3 via the personal computer 100 or to realize an interaction between the network terminals A1˜A3. Herein, the network terminals A1˜A3 may be digital appliances such as audiovisual players, air conditioning devices, video recording devices, or personal digital assistants (PDA).

As soon as the detection unit 111 detects that the network interface 120 provides the DHCP, i.e. the service device 130 exists and normally performs the function of providing the DHCP, the management device 110 gives control to the service device 130 for providing IP addresses to the personal computer 100 and the network terminals A1˜A3. In the meantime, the management device 110 does not function in the network interface 120. Provided that a shutdown suddenly occurs or the function of providing the DHCP is suddenly disabled while the service device 130 is connected to the network interface 120 via a wired or wireless transmission medium, conventionally the user needs to manually set up the addresses of the personal computer 100 and the network terminals A1˜A3, so as to construct the LAN for maintaining the connection and interaction therebetween. Such a setting procedure is complex and usually brings inconvenience to the user.

In this embodiment, the detection unit 111 detects whether or not the network interface 120 provides the DHCP every predetermined time. If the detection unit 111 detects that the network interface 120 does not provide the DHCP, i.e. the service device 130 is removed or the function of providing the DHCP is disabled, the control unit 112 provides static addresses to the personal computer 100 and the network terminals A1˜A3 according to the predetermined format, wherein the personal computer 100 is considered as one network terminal as well.

It is noted that the aforesaid static addresses must not conflict with one another in a system and an existing network device. For instance, the personal computer 100 may comprise two network cards, wherein one is connected to the communication network of the network terminals A1˜A3 while the other is connected to other communication networks. The static addresses provided by the control unit 112 must not conflict with one another in the existing network device, so as to avoid influencing the operation of other communication networks.

Hence, when the detection unit 111 detects that the network interface 120 does not provide the DHCP, the detection unit 111 further detects whether or not the request packets respectively sent by the personal computer 100 and the network terminals A1˜A3 comply with the predetermined format. The network terminal A3 is taken as an example for further explanation. Provided that the request packet of the network terminal A3 complies with the predetermined format, the control unit 112 calculates and manages unrepeated static addresses for the network terminal A3 to connect with the system, and sends a response packet comprising the static address to the network terminal A3. If the request packet of the network terminal A3 does not comply with the predetermined format, the management device 110 ignores the request packet, for the network terminal A3 does not belong to the LAN controlled and managed by the management device 110. Thereby, the personal computer 100 and the network terminals A1˜A3 which belong to the LAN controlled and managed by the management device 110 may be sifted out without influencing the operation of other communication networks.

If the network interface 120 provides the DHCP, i.e. the service device 130 has restored the function of providing the DHCP, while the personal computer 100 and the network terminals A1˜A3 have static addresses, the management device 110 then has to cancel the static addresses of the personal computer 100 and the network terminals A1˜A3 and controls the personal computer 100 and the network terminals A1˜A3 to request IP addresses again from the service device 130, so as to avoid conflicts caused by different address setting of the personal computer 100 and the network terminals A1˜A3.

In the meantime, the management device 110 checks whether or not the personal computer 100 and the network terminals A1˜A3 perform an initializing procedure. Take the network terminal A1 as an example, provided that the network terminal A1 has not yet performed the initializing procedure, i.e. the network terminal A1 logins the Internet for the first time, the network terminal A1 would not have network setting such as an IP address. Consequently, the control unit 112 controls the network terminal A1 to send a DHCP discover packet for broadcasting to the Internet. When receiving the DHCP discover packet, the service device 130 searches a database thereof for an unoccupied IP address and sends a DHCP offer packet comprising the unoccupied IP address and other network setting, such as a netmask and a default gateway, to the network terminal A1. The DHCP offer packet also comprises the information of an occupation term. After receiving the DHCP offer packet and accepting the IP address provided by the service device 130, the network terminal A1 sends a DHCP request packet to notify other service devices providing DHCP in the Internet that the network terminal A1 has adopted the information provided by the service device 130.

Provided that the network terminal A1 has completed the initializing procedure, the control unit 112 is only required to control the network terminal A1 to send the DHCP request packet. When the service device 130 receives the DHCP request packet, the service device 130 checks whether or not the information of the occupation term has expired. If the occupation term has not expired yet, the service device 130 replies a DHCPRESPONSE packet comprising the original IP address to the network terminal A1. Provided that the occupation term has expired, the service device 130 then replies the DHCPRESPONSE packet comprising a new IP address to the network terminal A1.

FIG. 1C is a diagram illustrating a local area network according to another embodiment of the present invention. Referring to FIGS. 1A and 1C, the management device 110 in this embodiment may also be disposed in a hub 140, but the present invention is not limited thereto. When the network interface 120 does not provide the DHCP, the management device 110 provides the static addresses to the hub 140, the personal computer 100, and the network terminals A1˜A3 to construct a local area network for interconnection and interaction, wherein the hub 140 and the personal computer 100 may be considered as network terminals as well. When the network interface 120 provides the DHCP, the hub 140, the personal computer 100, and the network terminals A1˜A3 operate by following the DHCP.

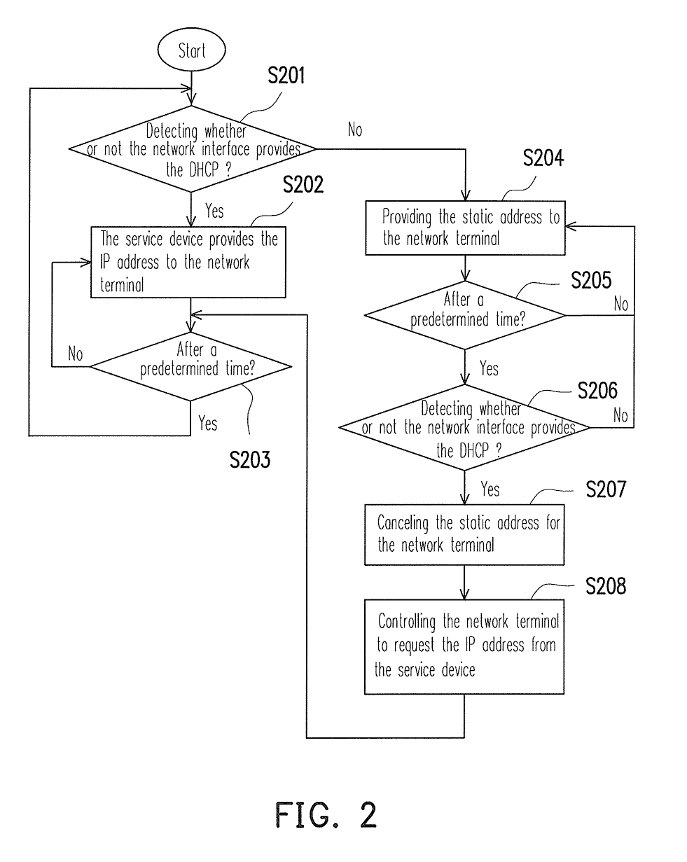

Based on the embodiments described above, the steps of a management method may be generalized as follows. FIG. 2 is a process flow illustrating a management method of local area network according to an embodiment of the present invention. First, referring to FIG. 2, the network interface is detected to check whether or not the DHCP is provided (Step S201), wherein the network interface is, for example, a physical layer element such as a wired network card, a wireless network card, or an infrared transceiver. When the network interface is detected to provide the DHCP, the control is given to the service device which provides the DHCP for providing the IP address to the network terminal (Step S202), wherein the service device is, for example, a router, a wireless network access point, or a DHCP server. The service device providing the DHCP may exist or be removed at any time. Even if the service device exists, the function of providing the DHCP may be disabled. Therefore, the network interface is detected every predetermined time (Step S203) to check whether or not the DHCP is provided (Step S201).

If the network interface does not provide the DHCP, the static address not conflicting with the existing network device is provided to the network terminal (Step S204). Then, the network interface is detected every predetermined time (Step S205) to check whether or not the network interface provides the DHCP (Step S206). At the same time, if the network interface is detected to provide the DHCP, i.e. the service device exists and normally performs the function of providing the DHCP, the original static address of the network terminal is canceled and the network terminal is controlled to request the service device to provide the IP address again (Step S208).

To conclude, the aforesaid embodiment is to timely and automatically provide the static address to the network terminal when the DHCP is not provided in the LAN. Through the aforesaid function of automatically distributing addresses, the complex procedure of setting up the address for each network terminal may be omitted, and the network terminals in the LAN may still connect and interact with one another via the static addresses. It is noted that, in the above embodiments, the request packet sent by the network terminal would be detected to check whether or not the request packet complies with the predetermined format, before the static address is provided to the network terminal. If the request packet complies with the predetermined format, the static address is provided to the network terminal. Otherwise, the request packet sent by the network terminal is ignored. Thereby, the network terminals in the LAN within control and management may be sifted out without influencing the operation of other communication networks.

When the DHCP is provided in the LAN, the static address of the network terminal is canceled and the network terminal is controlled to request the service device providing the DHCP to provide the IP address again. Consequently, the network terminal may operate to connect with the Internet by following the DHCP, and the conflicts caused by different address settings may be avoided.

Although the present invention has been disclosed by the above embodiments, they are not intended to limit the present invention. Anybody with ordinary knowledge in the art may make some modifications and alterations without departing from the spirit and scope of the present invention. Therefore, the protection range of the present invention falls in the appended claims.

What is claimed is:

1. A management method of local area network (LAN), applicable to a network terminal, comprising:
detecting whether or not a network interface provides a dynamic host configuration protocol (DHCP); and
providing a static address to the network terminal according to a predetermined format when the network interface does not provide the DHCP, and canceling the static address of the network terminal when the network interface provides the DHCP.

2. The management method as claimed in claim 1, wherein the steps of providing the static address to the network terminal, when the network interface does not provide the DHCP, comprise:
detecting whether or not a request packet sent by the network terminal complies with the predetermined format;
sending a response packet comprising the static address when the request packet complies with the predetermined format; and
ignoring the request packet when the request packet does not comply with the predetermined format.

3. The management method as claimed in claim 1, wherein the DHCP is provided by a service device.

4. The management method as claimed in claim 3, wherein the steps of canceling the static address of the network terminal, when the network interface provides the DHCP, further comprise:
checking whether or not the network terminal performs an initializing procedure;
enabling the network terminal to perform the initializing procedure when the network terminal has not yet performed the initializing procedure;
controlling the network terminal to send a DHCP request packet to the service device for providing an Internet protocol address to the network terminal when the network terminal has completed the initializing procedure.

5. The management method as claimed in claim 4, wherein the steps of providing the Internet protocol address to the network terminal comprise sending a DHCP response packet comprising the Internet protocol address to the network terminal when the service device receives the DHCP request packet.

6. The management method as claimed in claim 4, wherein the initializing procedure comprises:
controlling the network terminal to send a DHCP discover packet;
sending a DHCP offer packet to the network terminal when the service device receives the DHCP discover packet; and
sending the DHCP request packet to the service device when the network terminal receives the DHCP offer packet and allows the service device to provide the Internet protocol address.

7. The management method as claimed in claim 3, wherein the service device is a router, a network access point, or a DHCP server.

8. A management device of LAN, applicable to a network terminal, comprising:
a detection unit, detecting whether a network interface provides a DHCP; and
a control unit, coupled to the detection unit for providing a static address to the network terminal according to a predetermined format, when the detection unit detects that the network interface does not provide the DHCP, and canceling the static address of the network terminal when the network interface provides the DHCP.

9. The management device as claimed in claim 8, further comprising:
a database unit, coupled to the control unit for storing the static address.

10. The management device as claimed in claim 8, wherein the detection unit further detects whether a request packet sent by the network terminal complies with the predetermined format when the network interface does not provide the DHCP, and the control unit sends a response packet comprising the static address to the network terminal when the request packet complies with the predetermined format.

11. The management device as claimed in claim 10, wherein the request packet is ignored when the detection unit detects that the request packet does not comply with the predetermined format.

12. The management device as claimed in claim 8, wherein the DHCP is provided by a service device.

13. The management device as claimed in claim 12, wherein the control unit controls the network terminal to request the service device to provide an Internet address to the network terminal when the network interface provides the DHCP.

14. The management device as claimed in claim 12, wherein the service device is a router, a network access point, or a DHCP server.
